(19) United States
(12) Patent Application Publication
(10) Pub. No.: US 2006/0127059 A1
(43) Pub. Date: Jun. 15, 2006

(54) Media player with high-resolution and low-resolution image frame buffers

(76) Inventor: Blaise Fanning, Folsom, CA (US)

Correspondence Address: BUCKLEY, MASCHOFF, TALWALKAR LLC, 5 ELM STREET, NEW CANAAN, CT, 06840, US

(21) Appl. No.: 11/011,573

(22) Filed: Dec. 14, 2004

(51) Int. Cl. H04N 5/85

(52) U.S. Cl. 386/125

(57) ABSTRACT

According to some embodiments, a low-resolution buffer may be provided to store lower-resolution image frame information associated with first media content. A high-resolution buffer may also be provided to store higher-resolution image frame information also associated with the first media content. A playback device may then receive (i) the higher-resolution image frame information if the higher-resolution image frame information is available or (ii) the lower-resolution image frame information if the higher-resolution image frame information is not available.

### BACKGROUND

A media player may receive a stream of image information, including “image frames,” from a media server. For example, a content provider might transmit a stream that includes high-definition image frames to a television, a set-top box, or a digital video recorder through a cable or satellite network. In some cases, one or more these image frames might not be received by the media player (e.g., because one or more bits in the frame were corrupted as it traveled through the network). In this case, the media player may not be able to display the appropriate image. Typically, the media player will keep displaying the last valid image frame until the next valid image frame is determined. That is, the displayed image will appear to “freeze” when a valid image frame is not received by the media player. As another approach, the media player might display a blank (e.g., black) screen until the next valid image frame is found. With either approach, the effect may be disconcerting to a viewer and degrade the quality of his or her media experience.

### BRIEF DESCRIPTION OF THE DRAWINGS

FIG. 1 is a block diagram of a media system.

FIG. 2 is a representation of information being received by and provided from a media player buffer.

FIG. 3 is a representation of information being received by and provided from a media player buffer when image frames are lost.

FIG. 4 is a block diagram of a media system according to some embodiments.

FIG. 5 is a flow chart illustrating a media server method according to some embodiments.

FIG. 6 is a flow chart illustrating a media player method according to some embodiments.

FIG. 7 is a representation of information being received by and provided from media player buffers according to some embodiments.

FIG. 8 is a representation of information being received by and provided from media player buffers according to another embodiment.

FIG. 9 is a block diagram of a system according to some embodiments.

### DETAILED DESCRIPTION

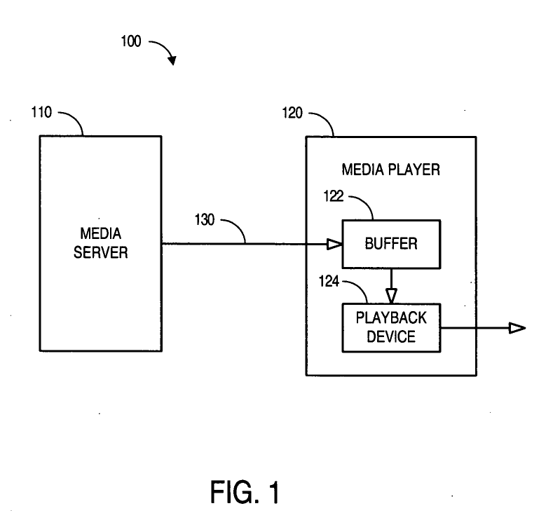

A person may receive media content, such as a television show, from a content provider. For example, FIG. 1 is a block diagram of a media system 100 according to some embodiments. In particular, a media server 110 may transmit a media information stream to a media player 120. The media player 120 might comprise or be associated with, for example, a television, a Personal Computer (PC), a game device, a digital video recorder, a set-top box, and/or a home digital media adapter device. The media information stream might be transmitted, for example, through a network 130 (e.g., a cable or satellite television network). As another example, a home Ethernet network might transmit media information in accordance with the Institute of Electrical and Electronics Engineers (IEEE) standard number 802.3 entitled “Carrier Sense Multiple Access with Collision Detection (CSMA/CD) Access Method and Physical Layer Specifications” (2002). As still another example, a home wireless network might transmit media information in accordance with IEEE standard number 802.11(g)(2003).

As used herein, the phrase “media information stream” may be associated with a signal that provides audio and video information. A television might, for example, be a Digital Television (DTV) signal associated with the Motion Picture Experts Group (MPEG) 1 protocol as defined by International Organization for Standardization (ISO)/International Engineering Consortium (IEC) document number 11172-1 entitled “Information Technology—Coding of Moving Pictures and Associated Audio for Digital Storage Media” (1993). Similarly, a signal may be a High Definition Television (HDTV) signal formatted in accordance with the MPEG4 protocol as defined by ISO/IEC document number 14496-1 entitled “Information Technology—Coding of Audio-Visual Objects” (2001). As still another example, the signal might be received from a storage device such a Video Cassette Recorder (VCR) or a Digital Video Disk (DVD) player in accordance with the MPEG2 protocol as defined by ISO/IEC document number 13818-1 entitled “Information Technology—Generic Coding of Moving Pictures and Associated Audio Information” (2000).

The phrase “media information stream” might also be associated with, for example, a proprietary format, such as a WINDOWS® Media Player file format. Examples of WINDOWS® Media Player file formats include Windows Media Video (.wmv), Windows Media Audio (.wma), Advanced Systems Format (.asf), and Digital Video Recording-Microsoft (.dvr-ms). Other types of media information streams include APPLE COMPUTER® QuickTime content (e.g., .mov or .qt), REALNETWORKS content (e.g., .ra, rm, or .ram), and Audio Visual Interleave files (.avi).

The media player 120 may store information received from the network 130 in a buffer 122, such as a Random Access Memory (RAM) unit. A playback device 124 may then retrieve information from the buffer 122 as needed and generate an output (e.g., to be provided to a display screen).

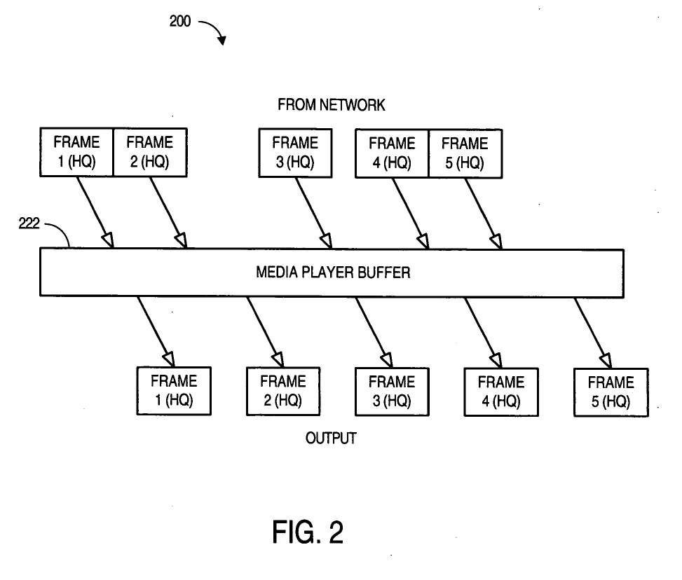

FIG. 2 is a representation 200 of information being received by and provided from a media player buffer 222. In particular, a stream of five high-quality image frames are received by and stored in the buffer 222. Moreover, the frames are provided from the buffer 222 as required (e.g., to a playback device that decodes the frames and generates an output for an HDTV device).

Note that the time between the received frames may vary, and in some cases frames may be received out of sequence. By storing the frames in the buffer 222, the media player can help ensure that appropriate frame will be available when needed by the playback device. The size of the buffer 222 may be based on an expected maximum amount of skew between the frames being received from the network and the frames being provided to the playback device.

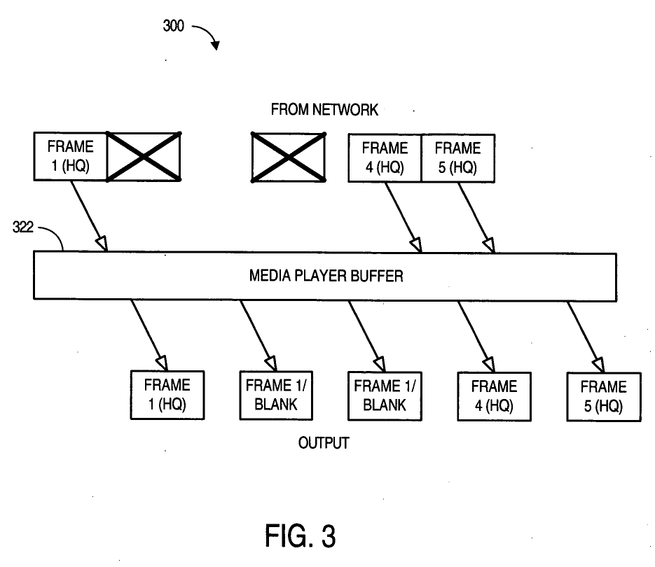

In some cases, however, one or more high-quality image frames may not be received by a media player. For example, a high-quality frame might be lost as it travels through the network. FIG. 3 is a representation 300 of information being received by and provided from a media player buffer 322 when image frames are lost. In this case, the second and third high-quality frames were never received by the media player. As a result, those frames were not in the buffer 322 when they were needed by a playback device. The playback device might, for example, repeat the first frame (e.g., “freezing” the picture) or provide a blank screen to a viewer. In either situation, the effect of losing these two image frames may reduce the quality of the media experience. Note that the fourth high-quality frame was in the buffer 322 when needed by the playback device, and the normal presentation of images resumed.

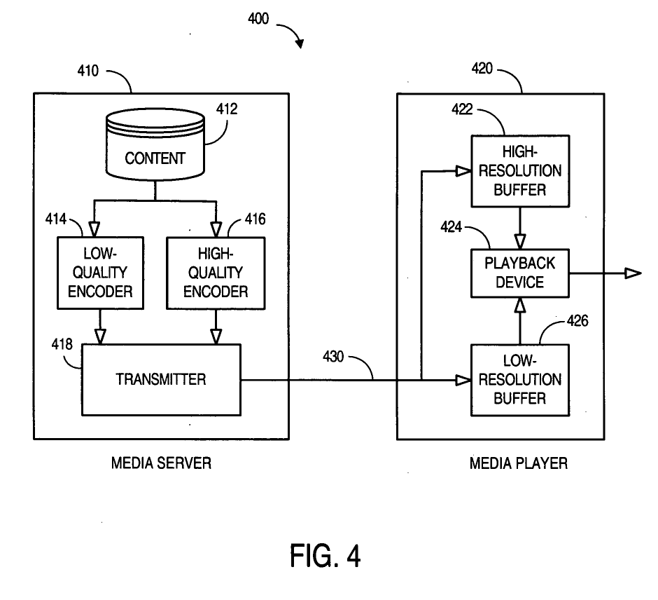

FIG. 4 is a block diagram of a media system 400 according to some embodiments. As before, a media server 410 may transmit a media information stream to a media player 420 through a network 430.

The media server 410 might be associated with, for example, a cable or satellite television service. The media server 410 includes a content storage unit 412 that may store, for example, information associated with a television program. A primary high-quality encoder 416 may use the information in the content storage unit 412 to generate an encoded, high-quality representation of the content (e.g., a high-resolution image frame). A transmitter 418 can then transmit these high-quality frames to a media player 420 through a network 430.

According to this embodiment, the media server 410 further includes a secondary low-quality encoder 414 that uses the same information in the content storage unit 412 to generate an encoded, low-quality representation of the content (e.g., a low-resolution image frame). The transmitter 418 also transmits these low-quality frames to a media player 420 through a network 430. Note that a low-quality frame may be transmitted to the media player 420 before the associated high-quality frame (e.g., the corresponding frame that represent the same image from the content storage unit 412). For example, the transmitter 418 might multiplex the two streams by including a high-quality frame several seconds after an associated low-quality frame has been inserted. Thus, a redundant, time-shifted, low-quality version of the content may be provided to the media player 420.

Although separate high-quality and low-quality encoders 416, 414 are illustrated in FIG. 4, both could be provided in a single device (e.g., a single encoder could generate both high-resolution and low-resolution image frames). As another approach, both high-quality and low-quality version of the content could be stored on a permanent medium.

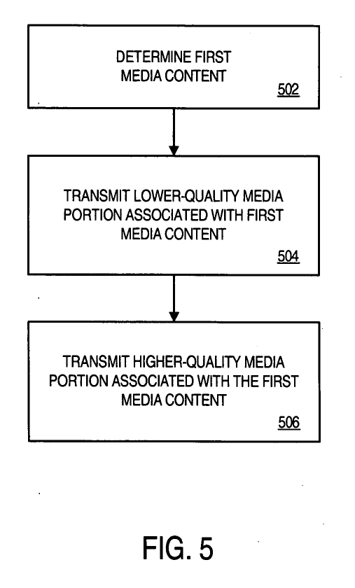

FIG. 5 is a flow chart illustrating a method according to some embodiments. The method may be performed, for example, by the media server 410. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 502, first media content is determined. The media content might be, for example, a portion of a television program. The media content may be determined based on, for example, a viewer's selection and/or a programming schedule. The media content is then used to generate a both a low-quality image signal and a high-quality image signal (e.g., low and high-quality MPEG image frames).

At 504, a lower-quality media portion associated with the first media content is transmitted. For example, a low-quality MPEP image frame can be transmitted to the media player 420 via the network 430.

At 506, a higher-quality media portion associated with the same media content is transmitted. For example, a high-quality MPEP image frame can be transmitted to the media player 420 via the network 430 after the associated low-quality frame was transmitted. The frames might be transmitted, for example, via an Elementary Stream (ES), a packetized ES (PES), and/or a Transport Stream (TS).

Referring again to FIG. 4, the media player 430 includes a high-resolution buffer 422 to store the high-quality frames received through the network 430 (e.g., from the media server 410). A playback device 424 may then use the stored high-quality frames to generate a high-quality output (e.g., to eventually be provided to a display screen).

According to this embodiment, the media player 430 also includes a low-resolution buffer 426 to store the low-quality frames received from the network 430. The high-resolution buffer 422 and/or low resolution buffer 426 may be hardware and/or software buffers and may be implemented using any appropriate device (e.g., a RAM unit or a hard disk drive).

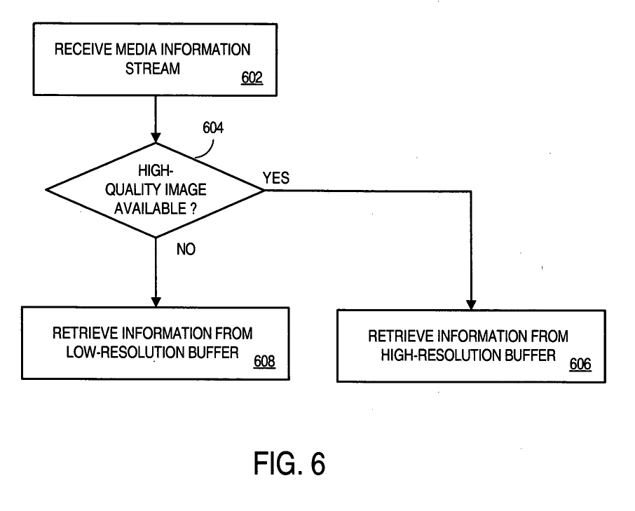

FIG. 6 is a flow chart illustrating a method according to some embodiments. At 602, a media information stream is received. The media information stream may include, for example, lower-quality media portions associated with first media content and higher-quality image portions also associated with the first media content.

At 604, it is determined if high-quality image information is currently available. For example, the playback device 424 might require a particular image frame, and it may be determined if a high-resolution version of that frame is currently stored in the high-resolution buffer 422.

If it is determined that a high-quality frame is available, the playback device 424 can retrieve the high-resolution information from the high-resolution buffer 422 at 606, and then use that information to generate an output.

If it is determined that a high-quality frame is not available, the playback device 424 can retrieve the low-resolution information from the low-resolution buffer 462 at 608, and then use that information to generate an output. In this way, the viewer will see a lower-quality version of the frame as opposed to the traditional blank or frozen display.

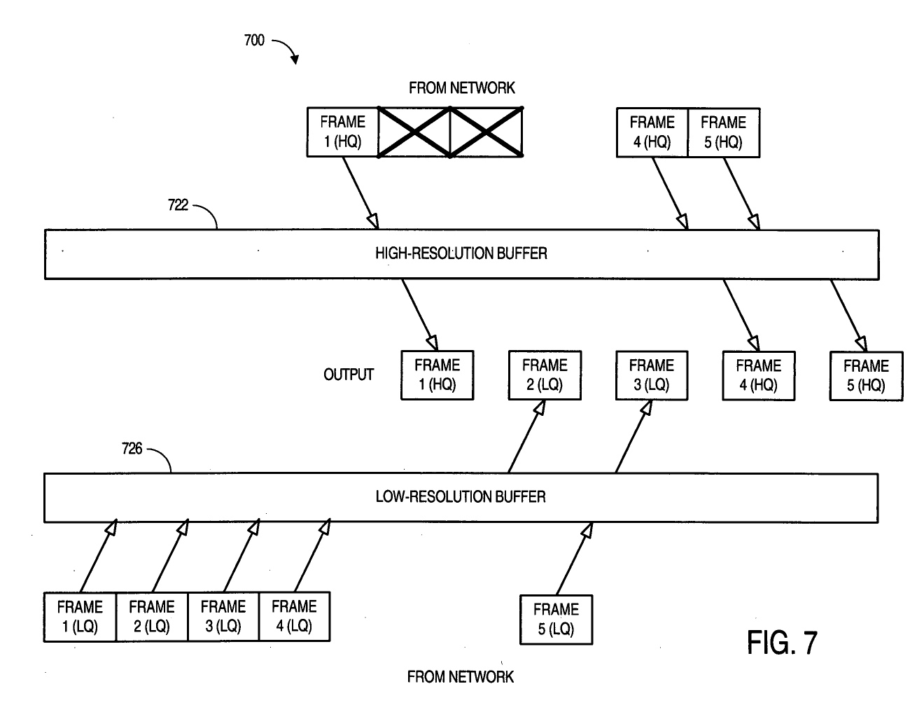

FIG. 7 is a representation 700 of information being received by and provided from media player buffers according to some embodiments. In this case, the second and third high-quality frames were never received by the media player, and therefore those frames were not in a primary, high-resolution buffer 722 when needed by a playback device. According to this embodiment, the playback device instead used lower-quality versions of those frames from a secondary, low-resolution buffer 726. Note that the fourth high-quality frame was in the buffer 722 when needed by the playback device, and the normal presentation of high-resolution images resumed.

A blank or frozen display might still occur if neither a high nor low-quality frame is available. However, because the low-quality frames are transmitted by the media server 410 in advance of the associated high-quality frames, the likelihood of such an occurrence may be reduced. That is, the delay between the transmission of the lower-bit rate image information and the higher-bit rate image information might be designed to tolerate a maximum expected length of a network disruption.

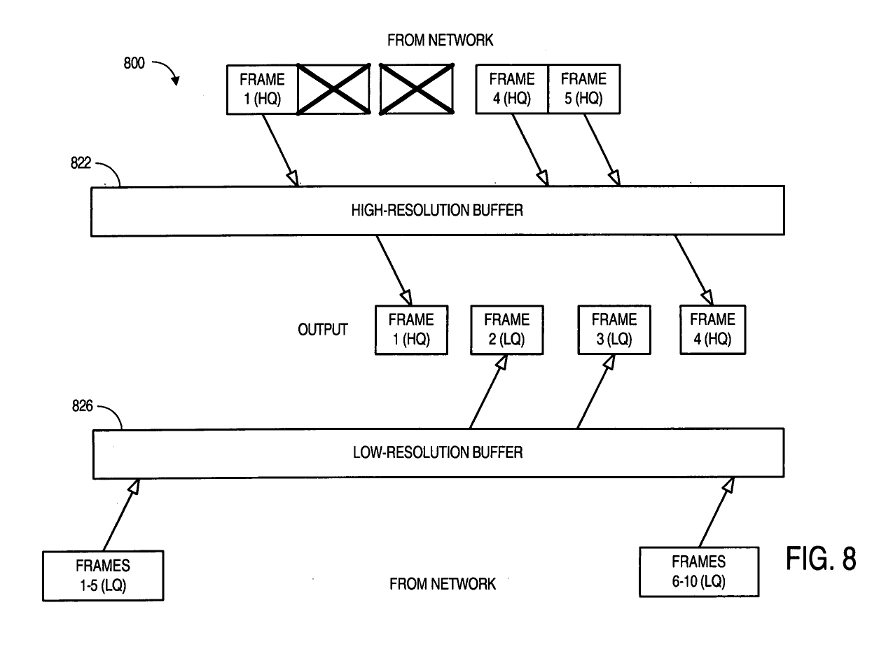

FIG. 8 is a representation 800 of information being received by and provided from media player buffers according to another embodiment. In this case, batches of low-bit rate, low-quality frames are stored in a low resolution buffer 826 in advance of the associated high-quality frames being stored in a high resolution buffer 822. As before, the lower-quality information may be used when the higher-quality information is not available.

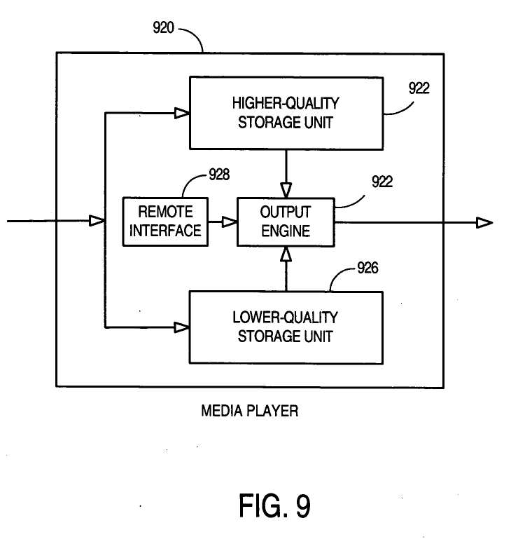

FIG. 9 is a block diagram of a system 920 according to some embodiments. The system 920 might be, for example, a set-top box or an HDTV tuner. The system 920 includes a lower-quality storage unit 926 to store lower-resolution image information associated with a picture, and a higher-quality storage unit 922 to store higher-resolution image information associated with the same picture. The system 920 may also include an output engine to receive (i) the higher-resolution image information if or when the higher-resolution image information is available and (ii) the lower-resolution image information if or when the higher-resolution image information is not available.

According to some embodiments, the system 920 further includes a remote interface 928 to facilitate control of the system 920. The remote interface 928 might, for example, let a user control the output engine 922 via an Infra-Red (IR) receiver or a wireless communication network (e.g., to pause or fast-forward a television program).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although some embodiments have been described with respect to separate higher-quality and lower-quality buffers, a single buffer could store both high-resolution and low-resolution image frames (and a playback device could move a buffer pointer in order to retrieve a lower-quality frame when no higher-quality frame is available). Similarly, although high-resolution information and low-resolution information are transmitted via a single network in some descriptions, these streams could be transmitted via different networks. For example, the high-resolution information might be transmitted through a satellite communication network while the low-resolution information is transmitted via an over-the-air television broadcast. In another embodiment, the high-resolution information might be transmitted through one type of wireless network (e.g., in accordance with IEEE standard number 802.11(a)) while low-resolution information is transmitted through a different type of wireless network (e.g., in accordance with IEEE standard number 802.11(b)).

Note that the delay between low-resolution frames and high-resolution frames may depend on network characteristics. According to some embodiments, the low-resolution frames are stored in one type of buffer (e.g., a buffer stored on a hard drive) and the high-resolution frames are stored in another type of buffer (e.g., a memory buffer).

Although some embodiments have been described with respect to television signals, any embodiment could instead be provided in a stereo or satellite radio device.

The several embodiments described herein are solely for the purpose of illustration. Persons skilled in the art will recognize from this description other embodiments may be practiced with modifications and alterations limited only by the claims.

What is claimed is:

1. A method, comprising:
receiving a lower-quality media portion in a media information stream, the lower-quality media portion being associated with first media content; and
receiving a higher-quality media portion in the media information stream, the higher-quality portion being (i) associated with the first media content and (ii) received after the lower-quality portion.

2. The method of claim 1, further comprising:
storing the lower-quality media portion in a secondary buffer;
storing the higher-quality media portion in a primary buffer; and
arranging for the higher-quality portion to be provided from the primary buffer.

3. The method of claim 2, further comprising:
determining that a particular higher-quality portion associated with second media content is not available in the primary buffer; and
arranging for a lower-quality portion associated with the second media content to be provided from the secondary buffer.

4. The method of claim 3, wherein the higher-quality portion is image information having a first resolution and the lower-quality portion is image information having a second resolution, the second resolution be less than the first resolution.

5. An apparatus, comprising:
a low-resolution buffer to store lower-resolution image frame information, the lower-resolution image frame information being associated with first media content;
a high-resolution buffer to store a higher-resolution image frame information associated with the first media content; and
a playback device to receive (i) the higher-resolution image frame information when the higher-resolution image frame information is available and (ii) the lower-resolution image frame information when the higher-resolution image frame information is not available.

6. The apparatus of claim 5, wherein at least one of the low-resolution and high-resolution buffers comprise at least one of a software buffer or a hardware buffer.

7. The apparatus of claim 5, wherein the low-resolution buffer is to store the lower-resolution image frame information before the high-resolution buffer is to store the higher-resolution image frame information

8. An apparatus comprising:
a storage medium having stored thereon instructions that when executed by a machine result in the following:
receiving a lower-quality frame of image information,
determining that no valid higher-quality frame associated with the lower-quality frame is available, and
arranging for the lower-quality frame to be provided to a playback device in place of the higher-quality frame.

9. The apparatus of claim 8, wherein the playback device is associated with at least one of: (i) a digital display device, (ii) a television, (iii) a personal video recorder, (iv) a game device, (v) a personal computer, (vi) a set-top box, or (vii) a home digital media adapter device.

10. The apparatus of claim 8, wherein said receiving is associated with at least one of: (i) a Motion Picture Experts Group protocol, (ii) a Windows media format, (iii) a QuickTime media format, or (iii) a RealNetworks media format.

11. The apparatus of claim 8, wherein execution of said instructions further result in:
receiving a second lower-quality frame of image information,
receiving a higher-quality frame, higher-quality frame being received after and associated with the second lower-quality frame of information, and
arranging for the higher-quality frame to be provided to the playback device.

12. A method, comprising:
transmitting a lower-quality media portion in a media information stream, the lower-quality media portion being associated with first media content; and
after the lower-quality media portion has been transmitted, transmitting a higher-quality media portion in the media information stream, the higher-quality portion also being associated with the first media content.

13. The method of claim 12, wherein the lower-quality media portion comprises an encoded low-resolution frame of image information and the higher-quality media portion comprises an encoded high-resolution frame of image information.

14. The method of claim 12, wherein said transmitting is performed via at least one of: (i) a cable-based communication network, (ii) a satellite communication network, (iii) an over-the-air television broadcast, or (iv) a wired Ethernet network, or (v) a wireless network.

15. An apparatus, comprising:
a media content storage unit;
a media server, including:
a primary unit to generate a high-resolution image frame to be included in
a media information stream, and
a secondary unit to generate a low-resolution image frame for the media information stream, the low-resolution image frame representing the same picture as the high-resolution image frame; and
a transmitter to first transmit the low-resolution image frame and then transmit the high resolution image frame in the media information stream.

16. The apparatus of claim 15, wherein at least one of the primary unit and the secondary unit operates in accordance with at least one of: (i) a Motion Picture Experts Group protocol, (ii) a Windows media format, (iii) a QuickTime media format, or (iii) a RealNetworks media format.

17. The apparatus of claim 15, wherein the transmitter transmits information via at least one of: (i) a cable-based communication network, (ii) a satellite communication network, (iii) an over-the-air television broadcast, or (iv) a wired Ethernet network, or (v) a wireless network.

18. An apparatus comprising:
a storage medium having stored thereon instructions that when executed by a machine result in the following:
determining media content to be provided via a communication network,
based on an image in the media content, generating a low-quality image signal,
based on the image, generating a high-quality image signal, and
arranging for the high-quality image signal to be transmitted after the low-quality image signal.

19. The apparatus of claim 18, wherein at least one of the low-quality image signal or high-quality image signal is encoded in accordance with at least one of: (i) a Motion Picture Experts Group protocol, (ii) a Windows media format, (iii) a QuickTime media format, or (iii) a RealNetworks media format.

20. The apparatus of claim 19, further comprising
multiplexing the low-quality image signal and the high-quality image signal in a transport stream.

21. A system, comprising:
a low-resolution storage unit to store lower-resolution image information, the lower-resolution image information being associated with a picture;
a high-resolution storage unit to store higher-resolution image information associated with the picture;
an output engine to receive (i) the higher-resolution image information if the higher-resolution image information is available or (ii) the lower-resolution image information if the higher-resolution image information is not available; and
a remote interface to facilitate operation of the system by a user.

22. The system of claim 21, wherein at least one of the low-resolution and high-resolution storage devices comprise at least one of a random access memory unit or a hard disk drive.

23. The system of claim 21, wherein the remote interface is associated with at least one of: (i) an infra-red receiver, or (ii) a wireless communication network.
